(19) United States
(12) Patent Application Publication
(10) Pub. No.: US 2006/0152934 A1
(43) Pub. Date: Jul. 13, 2006

(54) Luminaire having rotatable lampholder support

(76) Inventor: Serge Lavergne, LA MACHINE (FR)

Correspondence Address: PHILIPS INTELLECTUAL PROPERTY & STANDARDS, P.O. BOX 3001, BRIARCLIFF MANOR, NY, 10510, US

(21) Appl. No.: 10/543,430

(22) PCT Filed: Jan. 21, 2004
(86) PCT No.: PCT/IB04/00184

§ 371 Date: Jul. 26, 2005

(30) Foreign Application Priority Data
Jan. 29, 2003 (FR) 0300988

(51) Int. Cl. F21V 17/06

(52) U.S. Cl. 362/433; 362/285; 362/217

(57) ABSTRACT

The present invention relates to a luminaire of elongated shape comprising an elongated mounting-plate (1) carrying internal functional components of the luminaire. The mounting-plate comprises at least one lampholder-supporting tongue (3) that is cut out in the mounting-plate by punching. The tongue remains integrally connected to the plate and is capable of undergoing rotation through 90° from an initial position to an in-use position about a bending axis (7) along which the tongue is connected to the plate The mounting-plate also comprises an abutment (6), produced by stamping, which enables the rotation of the lampholder-supporting tongue to be limited to approximately 90°.

The present invention relates to a luminaire of elongated shape having an elongated mounting-plate supporting the internal functional components of the luminaire.

A conventional luminaire comprises a mounting-plate in which openings are made in such a way that a fitter can insert a pair of lampholders for a fluorescent tube, which lampholders pass through the plate. In a conventional luminaire of this type, the pair of lampholders are fixed through the plate by inserting them on the side opposite to the side to which the electrical wiring for said lampholders is fastened. The luminaire is therefore supplied with the lampholders not fitted; where there is more than one fluorescent tube, a fitter can therefore make a mistake when fixing the lampholders to the mounting-plate because the wiring for the lampholders is not accessible to him. Alternatively, the lumninaire is supplied with the lampholders already fitted to the mounting-plate but the package is then of a greater height due to the extra thickness caused by the lampholders.

Document DE 3 423 357 puts forward a solution to this problem. This comprises a lampholder device having a base part and a lampholder. The base part is fixed to the body of the luminaire and the lampholder is mounted to rotate on the base part. In this way, the lampholder is able to perform a rotary movement through approximately 90° from a storage position to an operational position.

However, this solution is particularly complex because it requires an additional component: the base part. There are costs involved in this additional component, on the one hand in terms of price and on the other in terms of fitting time.

It is an object of the present invention to put forward a luminaire as described in the opening paragraph that is of low cost and easy to fit while still being capable of being brought to a state where it is of reduced height for placing in packaging, and that is not conducive to errors when it is subsequently being installed.

To this end, the luminaire according to the invention is characterized in that the mounting-plate comprises at least one lampholder-supporting tongue that is cut out in the mounting-plate, said tongue remaining integrally connected to the mounting-plate and being capable of undergoing rotation from an initial position to an in-use position about a bending axis along which the tongue is connected to the mounting-plate.

The present invention thus does not require an additional component because the lampholder-supporting tongue is an integral part of the mounting-plate.

What is more, the lampholder can be fitted directly to the mounting-plate via the lampholder-supporting tongue. There is thus a reduction in fitting time because, in contrast to the prior art, there is no longer an additional component that has to be fixed to the mounting-plate.

The electrical test on the mounting-plate that is made on the assembly line no longer calls for the lampholders to be set to their in-use position and then returned to their initial positions after the test, because they are situated on the same side as the other functional components that have to be tested.

What is more, the height of the package containing the luminaire is reduced because the lampholder does not add any extra thickless due to the fact that it is situated on the same side as the other functional components and their wiring when the lampholder supporting-tongue is in its initial position.

Finally, the fitter does not have to fit the lampholders but only place the lampholder-supporting tongues in the in-use position and, if he has to wire them up, the wiring for them will be easily accessible to him. It is also open to him to adjust the rotation of the lampholder-supporting tongues in order to match up to the length of the fluorescent tube.

The present invention also relates to a method of producing a mounting-plate for a luminaire of an elongated type.

These and other aspects of the invention are apparent from and will be elucidated with reference to the embodiments described hereinafter, which are given by way of non-limiting example.

In the drawings:

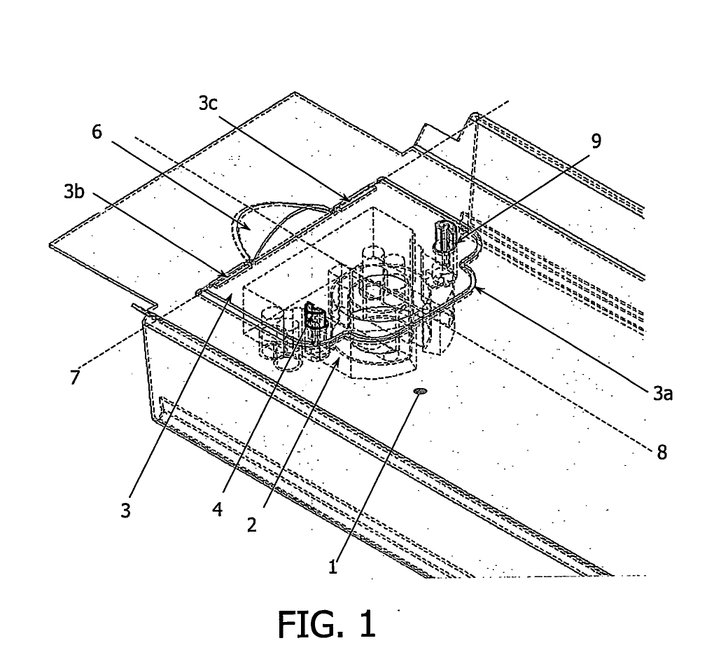

FIG. 1 is a perspective view of a mounting-plate for a luminaire of an elongated type comprising a lampholder-supporting tongue according to the invention, said tongue being in its initial position, and

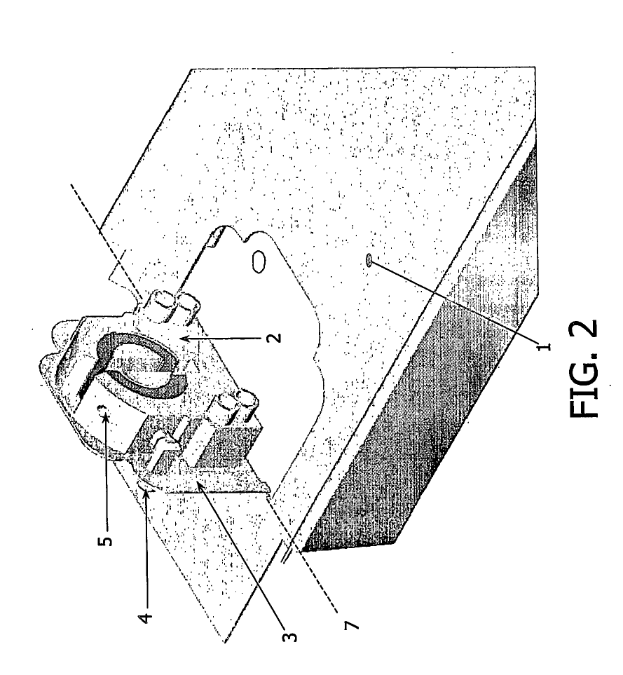

FIG. 2 is a perspective view of a mounting-plate for a luminaire of an elongated type comprising a lampholder-supporting tongue according to the invention, said tongue being in its in-use position.

The present invention relates principally to low-cost sealed luminaries. It employs standard items of equipment, particularly in respect of the lampholders, which are conventional low-cost lampholders, sometimes called flat lampholders.

A luminaire according to the invention comprises, amongst other things:

a body comprising a half-shell, termed a “roof”, which is equipped with means for fixing it to a support of any kind, such as a ceiling, for example,

a transparent cover or “diffuser”, which can be swung aside to give access to the interior of the luminaire,

a mounting-plate, made from a piece of profiled or indeed folded sheet metal, which carries internal functional components of the luminaire, these being, amongst other things, a ballast and lampholders for fluorescent tubes.

FIG. 1 is a perspective view of a mounting-plate (1) for a luminaire of an elongated type, comprising a lampholder-supporting tongue (3) according to the invention, said tongue being in its initial position. This position represents a configuration that is suitable:

for the fitting of components, such as lampholders (2) and ballasts for example, to the mounting-plate,

for the wiring-up of the components,

for checking that said components are working properly,

for storing the mounting-plate, together with the body of the luminaire, in a package to allow it to be transported.

As shown in FIG. 1, the lampholder-supporting tongue (3) is cut out of the sheet metal of the mounting-plate (1). A main cut (3a) substantially follows the shape of the lampholder (2). At least one ancillary cut (3b, 3c) is made along a bending axis (7), in the form of slots for example, the bending axis (7) being substantially perpendicular to the longitudinal axis (8) of the mounting-plate (1). This ancillary cut or these ancillary cuts make it easier for the lampholder-supporting tongue (3) to be rotated by bending on the bending axis (7). The cutting out of the lampholder-supporting tongue is performed by punching according to a principle familiar to the man skilled in the art of luminaires.

The lampholder-supporting tongue contains openings (9) suitable for receiving fixing lugs (4) of the lampholder (2). According to an embodiment of the invention, the lampholders are fixed in place by clipping the fixing lugs through openings (9) made by punching in the lampholder-supporting tongue. Said lugs are for example made of plastic material.

The mounting-plate (1) advantageously comprises an abutment (6), which allows the rotation by bending of the lampholder-supporting tongue (3) to be limited to approximately 900. This abutment is, for example, centered on the longitudinal axis (8) of the mounting-plate. According to an embodiment of the invention, the abutment is produced by stamping.

FIG. 2 is a perspective view of a mounting-plate (1) for a luminaire of an elongated type comprising a lampholder-supporting tongue (3) according to the invention, said tongue being in an in-use position. In said position, the lampholder-supporting tongue (3) is substantially perpendicular to the mounting-plate (1), said tongue being situated on the non-wired side of the mounting-plate.

When an installer is installing a luminaire, he rotates the lampholder-supporting tongue (3) through 90° by bending. He is then able to fit a fluorescent tube. This may be a fluorescent tube of the T5 or T8 type, for example.

Fluorescent tubes are subject to slight variations in size. The present invention makes possible for the fitter to adjust the rotation of the lampholder-supporting tongue (3) around the 90° position when fitting the tube into the lampholders (2).

The lampholder (2) also comprises test contacts (5) that make possible to check a proper operation of the luminaire on the assembly line.

No reference sign in parentheses in the present text is to be interpreted as being limitative. The verb “comprise” and conjugated forms thereof should is also to be broadly interpreted, i.e. not only as not excluding the presence of items or steps other than those listed after said verb, but also as not excluding the presence of more than one item or step that are listed after said verb and are preceded by the word “a” or “an”.

1. A luminaire of elongated shape comprising an elongated mounting-plate (1) supporting internal functional components of the luminaire, said mounting-plate comprising at least one lampholder-supporting tongue (3) that is cut out in the mounting-plate, said tongue remaining integrally connected to the mounting-plate and being capable of undergoing rotation from an initial position to an in-use position about a bending axis (7) along which the tongue is connected to the mounting-plate.

2. A luminaire as claimed in claim 1, wherein the mounting-plate comprises an abutment (6) that causes the rotation of the lampholder-supporting tongue (3) to be limited to approximately 90°.

3. A luminaire as claimed in claim 2, wherein the abutment (6) is a stamped abutment.

4. A luminaire as claimed in claim 1, wherein the lampholder-supporting tongue (3) is defined by a main cut (3a) and at least one ancillary cut (3b, 3c), said at least one ancillary cut being made along the bending axis (7).

5. A mounting-plate (1) for a luminaire of an elongated type, suitable for carrying internal functional components of the luminaire, said mounting-plate comprising at least one lampholder-supporting tongue (3) that is cut out in the mounting-plate, said tongue being capable of undergoing rotation from an initial position to an in-use position about a bending axis (7) along which the tongue is connected to the mounting-plate.

6. A mounting-plate as claimed in claim 1, comprising an abutment (6) that causes the rotation of the lampholder-supporting tongue (3) to be limited to approximately 90°.

7. A method of producing a mounting-plate (1) for a luminaire of an elongated type as claimed in claim 5, comprising a step of cutting out the lampholder-supporting tongue (3) by punching.

8. A method of producing a mounting-plate (1) for a luminaire of an elongated type as claimed in claim 6, comprising a step of stamping a part of the mounting-plate that is situated on the other side of the bending axis (7) from the lampholder-supporting tongue (3), in order to form an abutment (6).
